(19) United States
(12) Patent Application Publication
(10) Pub. No.: US 2006/0185432 A1
(43) Pub. Date: Aug. 24, 2006

(54) Five degree of freedom intertial measurement device

(76) Inventor: Harvey Weinberg, Sharon, MA (US)

Correspondence Address: BROMBERG & SUNSTEIN LLP, 125 SUMMER STREET, BOSTON, MA, 02110-1618, US

(21) Appl. No.: 11/331,596

(22) Filed: Jan. 13, 2006

Related U.S. Application Data
(60) Provisional application No. 60/643,530, filed on Jan. 13, 2005.

(51) Int. Cl. G01P 3/04

(52) U.S. Cl. 73/510

(57) ABSTRACT

A five degree of freedom inertial measurement unit capable of measuring: linear acceleration of a body along a first axis, a second axis, and a third axis; angular acceleration of the body about the second axis; and angular acceleration of the body about the third axis. The first axis, the second axis, and third axis are substantially mutually orthogonal and intersect at an origin point. The unit includes first and second accelerometers that are in fixed positions relative to the body. The first accelerometer measures linear acceleration along both the second axis and the third axis. The second accelerometer measures linear acceleration along both the second axis and third axis. The first and second accelerometers are positioned on a plane defined by the first axis and the second axis. A controller is operatively coupled to the first accelerometer and the second accelerometer. The controller determines the angular acceleration of the body about the second axis, and the angular acceleration of the body about the third axis. The controller determines angular acceleration using no other acceleration signals other than the linear acceleration signals from the first and second accelerometers.

### CROSS REFERENCE TO RELATED APPLICATIONS

The present application claims priority from U.S. Provisional patent application Ser. No. 60/643,530, entitled “Five Degree of Freedom Inertial Measurement Device,” filed Jan. 13, 2005, the contents of which are incorporated herein by reference.

### TECHNICAL FIELD

The present invention generally relates to the use of accelerometers for inertial measurement, and more particularly, to a five degree of freedom inertial measurement unit in which an arrangement of accelerometer sensors is used to measure linear and angular acceleration.

### BACKGROUND ART

Many types of hand held devices, such as remote controls, mobile phones, games, and cameras, benefit from knowing their orientation in space. Since portable devices can be held in almost any orientation, one would ideally need a six degree of freedom inertial measurement unit. As known in the art, a six degree of freedom inertial measurement unit provides data relating to 1) linear acceleration along three orthogonal axes (i.e., the X-axis, Y-axis, and Z-axis), and 2) rotational movement about those three axes (i.e., the pitch, roll, and yaw axes).

However, as a practical matter, such devices are normally operated such that only a five degrees of freedom inertial measurement unit is required. For example, while roll rate and yaw rate measurements may be of interest for an automobile, pitch rate is typically ignored. Various remote controls such as television remote controls, may require pitch rate and yaw rate for proper operation, but not roll rate.

Five degree of freedom inertial measurement units are typically are made by combining a plurality of linear accelerometer sensors with angular rate sensors (e.g., gyroscopes). For example, a conventional five degree of freedom accelerometer may include acceleration sensors for measuring linear acceleration along the three orthogonal axes, and additionally, two angular rate sensors for measuring rotation about two of those axes.

### SUMMARY OF THE INVENTION

In accordance with one aspect of the invention, a five degree of freedom inertial measurement unit is capable of measuring 1) linear acceleration of a body along a first axis, a second axis, and a third axis, 2) angular acceleration of the body about the second axis, and 3) angular acceleration about the third axis. The first axis, the second axis, and third axis are substantially mutually orthogonal and intersect at an origin point. To that end, the unit includes first and second accelerometers that are in fixed positions relative to the body. The first and second accelerometers each measure linear acceleration along both the second axis and the third axis. The first and second accelerometers are positioned on a plane defined by the first axis and the second axis. A controller, which is operatively coupled to the first accelerometer and the second accelerometer, determines the angular acceleration of the body about the second axis, and the angular acceleration of the body about the third axis. To that end, the controller uses no other acceleration signals other than the linear acceleration signals from the first and second accelerometers.

In related embodiments of the invention, the controller may include a first integrator for integrating the angular acceleration to obtain angular velocity. A second integrator may integrate the angular velocity to obtain angular position. Both the first accelerometer and second accelerometer may be fixed to the body such that they measure positive linear acceleration along the second axis in opposing directions. The controller may include a circuit operatively coupling first and second accelerometer outputs associated with the second axis, so as to output an angular acceleration signal proportional to the angular acceleration of the body across the second axis. The circuit may include a high pass filter for filtering the angular acceleration output. The circuit may include a first integration element for integrating the angular acceleration signal so as to output an angular velocity signal indicative of the angular velocity of the body across the second axis. The circuit may include a second integration element for integrating the angular velocity output so as to output an angular position signal indicative of the angular position of the body relative to the second axis.

In accordance with another aspect of the invention, a method is presented for measuring 1) linear acceleration of a body along a first axis, a second axis, and a third axis, 2) angular acceleration of the body about the second axis, and 3) angular acceleration of the body about the third axis. The first axis, the second axis, and third axis are substantially mutually orthogonal and intersect at an origin point. The method includes positioning first and second accelerometers in fixed positions relative to the body. The first and second accelerometers each measure linear acceleration along both the second axis and the third axis. The first and second accelerometers are positioned on a plane defined by the first axis and the second axis. An angular acceleration of the body is determined about the second axis, and an angular acceleration is determined about the third axis, using no other acceleration signals other than the linear acceleration signals from the first and second accelerometers.

In accordance with related embodiments of the invention, positioning the first accelerometer and the second accelerometer may include fixing the first and second accelerometers to the body such that they measure positive linear acceleration along the second axis in opposing directions. Angular acceleration of at least one of the first axis and second axis may be integrated to obtain an angular velocity of the body across the at least one of the first axis and the second axis. The angular velocity may be further integrated across the at least one of the first axis and the second axis to obtain an angular position of the body across the at least one of the first axis and the second axis.

In accordance with still another aspect of the invention, a five degree of freedom inertial measurement unit is capable of measuring 1) linear acceleration of a body along a first axis, a second axis, and a third axis, 2) angular acceleration of the body about the second axis, and 3) angular acceleration of the body about the third axis. The first axis, the second axis, and third axis are substantially mutually orthogonal and intersect at an origin point. The unit includes first and second accelerometers that are in fixed positions relative to the body. The first and second accelerometers each measure linear acceleration along both the second axis and the third axis. The first and second accelerometers are positioned on a plane defined by the first axis and the second axis. The unit further includes a means for determining an angular acceleration of the body about the second axis, and an angular acceleration of the body about the third axis,. To that end, the determining means uses no other acceleration signals other than the linear acceleration signals from the first and second accelerometers.

In related embodiments of the invention, the means for determining may include a first integrator for integrating the angular acceleration to obtain angular velocity. A second integrator may integrate the angular velocity to obtain angular position. Both the first accelerometer and second accelerometer may be fixed to the body such that they measure positive linear acceleration along the second axis in opposing directions. The means for controlling may include a circuit operatively coupling first and second accelerometer outputs associated with the second axis, so as to output an angular acceleration signal proportional to the angular acceleration of the body across the second axis. The circuit may include a high pass filter for filtering the angular acceleration output. The circuit may include a first integration element for integrating the angular acceleration signal so as to output an angular velocity signal indicative of the angular velocity of the body across the second axis. The circuit may include a second integration element for integrating the angular velocity output so as to output an angular position signal indicative of the angular position of the body relative to the second axis.

In some embodiments, at least one of the first accelerometer and the second accelerometer may be a tri-axial accelerometer, the tri-axial accelerometer measuring linear acceleration along the first, second and third axis. No other acceleration signals other than the linear acceleration signals from the first and second accelerometers are used in determining 1) linear acceleration of the body along the first axis, the second axis, and the third axis, 2) angular acceleration of the body about the second axis, and 3) angular acceleration of the body about the third axis.

In still other embodiments, a third accelerometer may measure linear acceleration along the first axis. No other acceleration signals other than the linear acceleration signals from the first, second and third accelerometers are used in determining 1) linear acceleration of the body along the first axis, the second axis, and the third axis, 2) angular acceleration of the body about the second axis, and 3) angular acceleration of the body about the third axis.

### BRIEF DESCRIPTION OF THE DRAWINGS

The foregoing features of the invention will be more readily understood by reference to the following detailed description, taken with reference to the accompanying drawings, in which:

FIG. 1(a) schematically shows a five degree of freedom inertial measurement system that uses two tri-axial linear accelerometers, in accordance with an embodiment of the invention;

FIG. 1(b) schematically shows the controller of FIG. 1(a) in more detail, in accordance with an embodiment of the invention;

FIG. 2 schematically shows an accelerometer accelerating about a point;

FIG. 3 schematically shows a five degree of freedom inertial measurement system that uses three dual axis accelerometers, in accordance with an embodiment of the invention;

FIG. 4 schematically shows a five degree of freedom inertial measurement system that uses one tri-axial accelerometer and one dual axis accelerometer, in accordance with an embodiment of the invention; and

FIG. 5 schematically shows a circuit for the yaw rate channel of FIG. 1, in accordance with an embodiment of the invention.

### DETAILED DESCRIPTION OF SPECIFIC EMBODIMENTS

In illustrative embodiments, a five degree of freedom inertial measurement unit uses a minimal number of linear accelerometers to determine both linear and angular acceleration. Thus, the unit requires no angular rate sensors. Furthermore, the unit has an efficient circuit that uses linear accelerometers to obtain angular acceleration, angular rate and/or angular position. Details are discussed below.

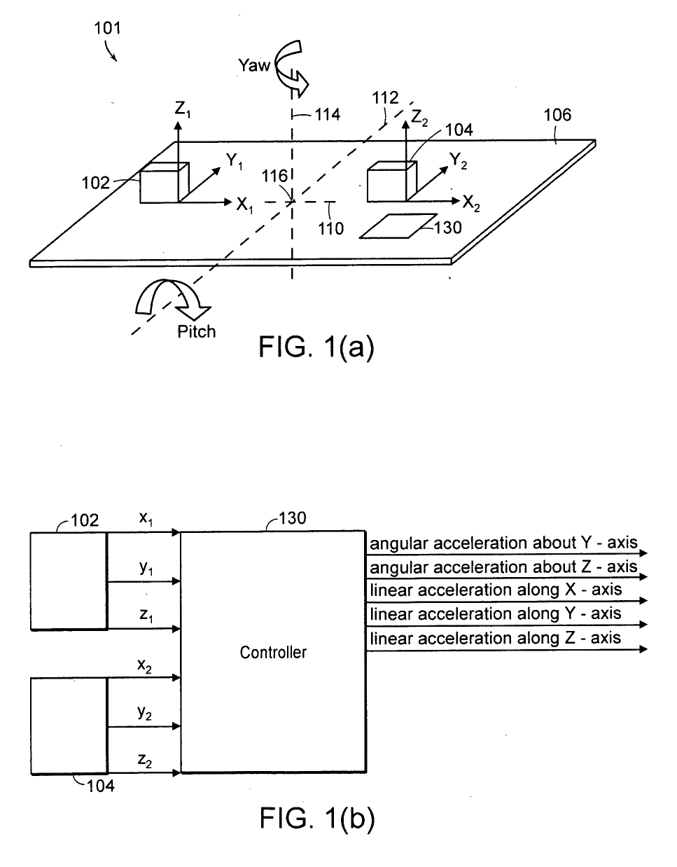

FIG. 1(a) schematically shows a five degree of freedom inertial measurement unit configured in accordance with one embodiment of the invention. By using first and second linear accelerometers 102 and 104, the five degree of freedom inertial measurement unit can determine linear acceleration of a body 106 along a first, second, and third axes 110, 112, and 114, as well as angular acceleration of the body 106 about the second third axes 112 and 114. The first axis 110 (referred to herein as the X-axis), second axis 112 (referred to herein as the Y-axis), and third axis 114 (referred to herein as the Z-axis) illustratively are substantially mutually orthogonal and intersect at an origin point 116.

The first accelerometer 102 is fixed to a body 106 and measures linear acceleration along three axes X₁, Y₁ and Z₁ that are parallel to the X-axis 110, Y-axis 112 and Z-axis 114, respectively. In a corresponding manner, the second accelerometer 104 also is fixed to the body 106 and measures linear acceleration along three axes X₂, Y₂ and Z₂, that are parallel to the X-axis 110, Y-axis 112 and Z-axis 114, respectively. The first and second accelerometers 102 and 104 are positioned to be a specified distance apart from each other and furthermore, are positioned on a plane defined by the X-axis 110 and the Y-axis 112.

A controller 130 operatively coupled with the two accelerometers 102 and 104 determines the angular acceleration of the body about the Y and Z axes 112 and 114, and linear acceleration along the X, Y and Z axes 110, 112, and 114. In illustrative embodiments, the controller determines these values by using no other acceleration signals other than the linear acceleration signals from the first and second accelerometers 102 and 104. The controller 130 may integrate the angular acceleration to determine angular rate (i.e., angular velocity). Furthermore, the controller 130 may integrate the angular rate to determine angular position.

The controller 130, which is shown in greater detail in FIG. 1(b), may be implemented in hardware and/or software in a conventional manner to perform various portions of the discussed functions. For example, the controller may include, without limitation, software, firmware, a circuit, application specific integrated circuits, memory devices, FPGAs, digital signal processors, and/or microprocessors. In various embodiments, the controller 130 may be integrated with accelerometers 102 and/or 104, and/or an independent chip that is fixedly secured to the body 106.

The controller 130 may determine acceleration in a number of ways. For example, the angular acceleration about the Z-axis (referred to herein as yaw) is proportional to (Y₁-Y₂)*(d_{Y1-Y2}): where 1) Y₁ is the acceleration measured by the first accelerometer 102 along the Y-axis, 2) Y₂ is the acceleration measured by the second accelerometer 104 along the Y-axis, and 3) d_{Y1-Y2} is the distance between the accelerometers 102 and 104 that measure the acceleration along the Y-axis.

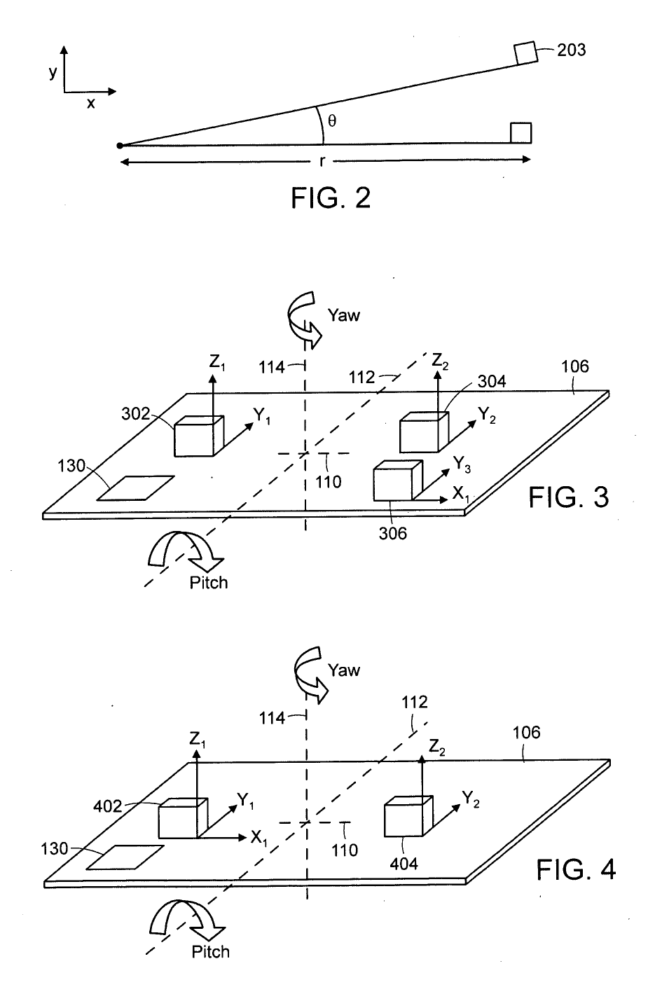

To assist in deriving yaw, FIG. 2 shows a single accelerometer 203 having an angular acceleration about a point at time t₁ and time t₂. The angle θ(t) between the starting position and the ending position is ωt, where ω=2πf. The relationship between position y(t), velocity y′(t), and acceleration y″(t), are as follows:
y(t)=r*SIN ωt (1)
y′(t)=r*ω*COS ωt (2)
y″(t)=−r*ω²*SIN ωt(3)

Returning back to FIG. 1, and assuming small amounts of vibration (e.g., where a user is trying to hold a camera still), the yaw acceleration and pitch acceleration can therefore be described as:
Yaw acceleration=4*π²*f²*d_{Y1-Y2}*SIN θ (4)
Pitch acceleration=4*π²*f²*d_{Z1-Z2}*SIN θ (5)

Angular rate is the integral of the above:
Yaw rate=4*d_{Y1-Y2}*π*f*COS(2*π*f) (6)
Pitch rate=b 4*d_{Z1-Z2}*π*f*COS(2*π*f) (7)

As can be seen from the formulas above, the distance (d) can be varied to suit the application. For example, if small angular rates must be measured, d can be increased to improve sensitivity. If d is reduced to zero, there is no sensitivity to angular rate.

In a similar manner, the angular acceleration about the Y-axis (referred to herein as pitch) is proportional to (Z₁-Z₂)*(d_{Z1-Z2}), where: 1) Z₁ is the acceleration measured by the first accelerometer 102 along the Z-axis, 2) Z₂ is the acceleration measured by the second accelerometer 104 along the Z-axis, and 3) d_{Z1-Z2} is the distance between the accelerometers 102 and 104 that measure the acceleration along the Z-axis.

Note that the Y-axis can be moved along the X-axis without changing the above derived yaw or pitch. Similarly, the Z-axis may be moved along the X-axis without changing the derived signals.

By using two accelerometers, the subtraction of (Y₁-Y₂) in calculating yaw advantageously rejects translational motion along the Y-axis, leaving only angular acceleration across the Y-axis. Similarly, the subtraction of (Z₁-Z₂) in calculating pitch rejects translational motion along the Z-axis, leaving only angular acceleration across the Z-axis.

Alternative embodiments may use other accelerometer configurations. For example, FIG. 3 schematically shows a five degree of freedom inertial measurement system that uses three dual axis accelerometers 302, 304, and 306, in accordance with an embodiment of the invention. As another example, FIG. 4 schematically shows a five degree of freedom inertial measurement system having one tri-axial accelerometer 402 and one dual axis accelerometer 404, in accordance with an embodiment of the invention. With regard to the embodiments shown in FIGS. 3 and 4, the principles of operation and mathematics describing operation are similar to those described with regard to FIG. 1. More particularly, no other acceleration signals other than the linear acceleration signals from the first, second and/or third accelerometers are used in determining 1) linear acceleration of the body along the first axis, the second axis, and the third axis, 2) angular acceleration of the body about the second axis, and 3) angular acceleration about the third axis.

Illustrative embodiments of the invention simplify accelerometer signal conditioning by mounting the accelerometers such that certain measurement directions oppose each other. For example, with regard to FIG. 1, the accelerometers 102 and 104 may be positioned such that the positive Z directions of accelerometers 102 and 104 are opposed, and/or such that the positive Y directions of accelerometers 102 and 104 are opposed. For yaw, this advantageously allows the calculation of (Y₁-Y₂) to be performed by summing, and not subtracting, the outputs Y₁ and Y₂ associated with the first and second accelerometers 102 and 104, respectively. Similarly, for pitch, the calculation of (Z₁-Z₂) can be calculated by summing the outputs Z₁ and Z₂ associated with the first and second accelerometers 102 and 104.

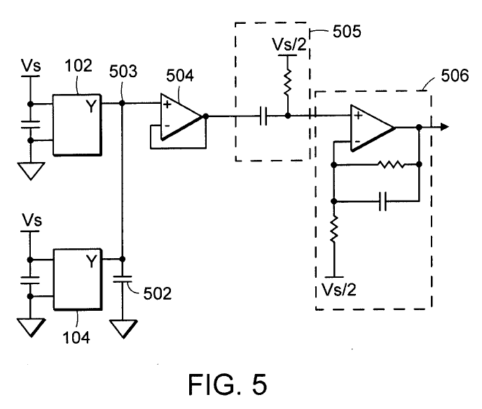

The units shown in FIGS. 1, 3 and 4 may use a number of different circuit configurations for determining yaw rate and/or pitch rate. For example, FIG. 5 schematically shows a circuit within the controller 130 for determining yaw rate. It is assumed that the accelerometer outputs along Y₁ and Y₂ are opposed. Furthermore, it is assumed that the accelerometer outputs Y₁ and Y₂ have an internal resistor, or alternatively, an external resistor may be used in series with their output. The circuit includes the two accelerometers 102 and 104 having their Y₁ and Y₂ outputs summed together at a node 503 to obtain their sum. A capacitor 502 operatively coupled to the node 503 works in combination with the internal resistor associated with the Y₁ and Y₂ outputs to perform integration, such that yaw rate is obtained. A similar circuit attached to the Z₁ and Z₂ outputs may be used to calculate the pitch rate.

Additional circuitry may include a buffer 504, and/or a high pass filter 505 to exclude DC response. The circuit may also include an output gain/buffer stage 506.

The accelerometers in the above-described embodiments may be of various types known in the art. For example, the accelerometers may be a multi-axis capacitive sensor of the type described in U.S. Pat. No. 5,939,633, which is hereby incorporated by reference in its entirety. An exemplary three-axis accelerometer is distributed by Analog Devices, Inc. of Norwood, Mass. and is described generally in the ADXL330 Three-axis Accelerometer data sheet, which is hereby incorporated herein by reference in its entirety. An exemplary two-axis accelerometer, also distributed by Analog Devices, Inc., is described generally in the ADXL322 Dual-axis Accelerometer data sheet, which is hereby incorporated herein by reference in its entirety.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer exec structure form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer execustructure form (e.g., via an interpreter), or the source code may be converted (e.g., via a translator, assembler, or compiler) into a computer executable structure form.

The computer program may be fixed in any form (e.g., source code form, computer execustructure form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Although the above discussion discloses various exemplary embodiments of the invention, it should be apparent that those skilled in the art can make various modifications that will achieve some of the advantages of the invention without departing from the true scope of the invention. Other variations and modifications of the embodiments described above are intended to be within the scope of the present invention as defined in the appended claims.

What is claimed is:

1. A five degree of freedom inertial measurement unit capable of measuring linear acceleration of a body along a first axis, a second axis, and a third axis, angular acceleration of the body about the second axis, and angular acceleration of the body about the third axis, wherein the first axis, the second axis, and third axis are substantially mutually orthogonal and intersect at an origin point, the unit comprising:
a first accelerometer in a fixed position relative to the body, the first accelerometer measuring linear acceleration along both the second axis and the third axis;
a second accelerometer in a fixed position relative to the body, the second accelerometer measuring linear acceleration along both the second axis and third axis, the first and second accelerometers positioned on a plane defined by the first axis and the second axis, and
a controller operatively coupled to the first accelerometer and the second accelerometer, the controller determining the angular acceleration of the body about the second axis, and the angular acceleration of the body about the third axis, the controller determining angular acceleration using no other acceleration signals other than the linear acceleration signals from the first and second accelerometers.

2. The inertial measurement unit according to claim 1, wherein at least one of the first accelerometer and the second accelerometer is a tri-axial accelerometer, the tri-axial accelerometer measuring linear acceleration along the first, second and third axis, and wherein no other acceleration signals other than the linear acceleration signals from the first and second accelerometers are used in determining linear acceleration of the body along the first axis, the second axis, and the third axis, angular acceleration of the body about the second axis, and angular acceleration of the body about the third axis.

3. The inertial measurement unit according to claim 1, further comprising a third accelerometer that measures linear acceleration along the first axis, wherein no other acceleration signals other than the linear acceleration signals from the first, second and third accelerometers are used in determining linear acceleration of the body along the first axis, the second axis, and the third axis, angular acceleration of the body about the second axis, and angular acceleration of the body about the third axis.

4. The inertial measurement unit according to claim 1, wherein the first accelerometer and second accelerometer are fixed to the body such that they measure positive linear acceleration along the second axis in opposing directions.

5. The inertial measurement unit according to claim 4, wherein the controller includes a circuit operatively coupling first and second accelerometer outputs associated with the second axis, so as to output an angular acceleration signal proportional to the angular acceleration of the body across the second axis.

6. The inertial measurement unit according to claim 5, wherein the circuit further comprises a high pass filter for filtering the angular acceleration output.

7. The inertial measurement unit according to claim 5, wherein the circuit further comprises a first integration element for integrating the angular acceleration signal so as to output an angular velocity signal indicative of the angular velocity of the body across the second axis.

8. The inertial measurement unit according to claim 7, wherein the circuit further comprises a second integration element for integrating the angular velocity output so as to output an angular position signal indicative of the angular position of the body relative to the second axis.

9. The inertial measurement unit according to claim 1, the controller further including a first integrator for integrating the angular acceleration to obtain angular velocity.

10. The inertial measurement unit according to claim 9, the controller further including a second integrator for integrating the angular velocity to obtain angular position.

11. A method of measuring linear acceleration of a body along a first axis, a second axis, and a third axis, angular acceleration of the body about the second axis, and angular acceleration of the body about the third axis, wherein the first axis, the second axis, and third axis are substantially mutually orthogonal and intersect at an origin point, the method comprising:
positioning a first accelerometer in a fixed position relative to the body, the first accelerometer measuring linear acceleration in directions along both the second axis and the third axis;
positioning a second accelerometer in a fixed position relative to the body, the second accelerometer measuring linear acceleration in directions along both the second axis and third axis, the first and second accelerometers positioned on a plane defined by the first axis and the second axis, and
determining an angular acceleration of the body about the second axis, and an angular acceleration of the body about the third axis, using no other acceleration signals other than the linear acceleration signals from the first and second accelerometers.

12. The method according to 11, wherein at least one of the first accelerometer and the second accelerometer is a tri-axial accelerometer, the tri-axial accelerometer measuring linear acceleration along the first, second and third axis, and wherein no other acceleration signals other than the linear acceleration signals from the first and second accelerometers are used in determining linear acceleration of the body along the first axis, the second axis, and the third axis, angular acceleration of the body about the second axis, and angular acceleration of the body about the third axis.

13. The method according to claim 11, further comprising positioning a third accelerometer on the body for measuring linear acceleration along the first axis, wherein no other acceleration signals other than the linear acceleration signals from the first, second and third accelerometers are used in determining linear acceleration of the body along the first axis, the second axis, and the third axis, angular acceleration of the body about the second axis, and angular acceleration of the body about the third axis.

14. The method according to claim 11, wherein positioning the first accelerometer and the second accelerometer includes fixing the first and second accelerometers to the body such that they measure positive linear acceleration along the second axis in opposing directions.

15. The method according to claim 11, further comprising integrating angular acceleration of at least one of the first axis and second axis to obtain an angular velocity of the body across the at least one of the first axis and the second axis.

16. The method according to claim 15, further comprising integrating the angular velocity across the at least one of the first axis and the second axis to obtain an angular position of the body across the at least one of the first axis and the second axis.

17. A five degree of freedom inertial measurement unit capable of measuring linear acceleration of a body along a first axis, a second axis, and a third axis, angular acceleration of the body about the second axis, and angular acceleration of the body about the third axis, wherein the first axis, the second axis, and third axis are substantially mutually orthogonal and intersect at an origin point, the unit comprising:
a first accelerometer in a fixed position relative to the body, the first accelerometer measuring linear acceleration in directions along both the second axis and the third axis;
a second accelerometer in a fixed position relative to the body, the second accelerometer measuring linear acceleration in directions along both the second axis and third axis, the first and second accelerometers positioned on a plane defined by the first axis and the second axis, and
means for determining an angular acceleration of the body about the second axis, and an angular acceleration of the body about the third axis, using no other acceleration signals other than the linear acceleration signals from the first and second accelerometers.

18. The inertial measurement unit according to claim 18, wherein at least one of the first accelerometer and the second accelerometer is a tri-axial accelerometer, the tri-axial accelerometer measuring linear acceleration along the first, second and third axis, and wherein the means for determining uses no other acceleration signals other than the linear acceleration signals from the first and second accelerometers to determine linear acceleration of the body along the first axis, the second axis, and the third axis, angular acceleration of the body about the second axis, and angular acceleration of the body about the third axis.

19. The inertial measurement unit according to claim 18, further comprising a third accelerometer that measures linear acceleration along the first axis, wherein the means for determining uses no other acceleration signals other than the linear acceleration signals from the first, second and third accelerometers to determine linear acceleration of the body along the first axis, the second axis, and the third axis, angular acceleration of the body about the second axis, and angular acceleration of the body about the third axis.

20. The inertial measurement unit according to claim 18, wherein the first accelerometer and second accelerometer are fixed to the body such that they measure positive linear acceleration along the second axis in opposing directions.
